(19) United States
(12) Patent Application Publication
(10) Pub. No.: US 2009/0187035 A1
(43) Pub. Date: Jul. 23, 2009

(54) Process for production of fatty acid alkyl esters

(75) Inventors: Myong Ko, Lakeville, MN (US); Krishna Kumar N.S., Savage, MN (US); John Hahn, Apple Valley, MN (US); Harapanahalli S. Muralidhara, Plymouth, MN (US)

Correspondence Address: CARGILL, INCORPORATED, P.O. Box 5624, MINNEAPOLIS, MN, 55440-5624, US

(73) Assignee: Cargill, Incorporated

(21) Appl. No.: 12/009,839

(22) Filed: Jan. 22, 2008

(51) Int. Cl. C11C 1/06

(52) U.S. Cl. 554/168

(57) ABSTRACT

A system and method for producing fatty acid alkyl esters is provided. The method includes forming a reactant stream, which includes triacylglycerides, alkanol, basic transesterification catalyst and, optionally, glycerol, and mixing the reactant stream under high shear mixing conditions to provide a mixed stream comprising fatty acid alkyl ester.

### BACKGROUND

Biodiesel is a fuel prepared from renewable sources, such as plant oils or animal fats. To produce biodiesel, triacylglycerides (“TAG”), the major compound in plant oils and animal fats, are converted to fatty acid alkyl esters (“FAAE,” i.e. biodiesel) and glycerol via reaction with an alcohol in the presence of a base, acid, or enzyme catalyst.

Biodiesel fuel can be used in diesel engines, either alone or in a blend with petroleum-based diesel, and has a number of advantages over diesel fuel derived from petroleum. For example, since biodiesel is produced from renewable starting materials, it is, unlike petroleum-based diesel, a renewable fuel. Biodiesel is also nontoxic, biodegradable, and has a low emission profile.

Large-scale production of biodiesel typically requires the use of significant amounts of catalyst, which can be costly in terms of reagent purchase and costs associated with treatment and disposal of the resulting catalyst-enriched waste stream. Accordingly, there is a continuing need for alternative biodiesel fuel production methods which utilize minimum amounts of catalyst while still producing maximum conversion of TAG to biodiesel.

### SUMMARY

The application is directed to methods of producing fatty acid alkyl esters (“FAAE”) from triacylglycerides via a process comprising transesterification. In many embodiments, the process includes mixing a reactant stream, which includes triacylglycerides, alkanol and a basic transesterification catalyst, under high shear mixing conditions. After being subjected to high shear mixing, the mixture is typically allowed further time to react, e.g., by passing a high shear mixed stream through a vessel where the mixed stream is typically maintained under low shear mixing conditions. Although the process of producing the fatty acid alkyl esters may be conducted in a variety of modes, including as a batch operation, it is often desirable to conduct the process as a continuous operation. The transesterification process may often be conducted as a multi-stage operation where substantial conversion of triacylglycerides into fatty acid alkyl esters is achieved in a first reaction stage and one or more subsequent stages is employed to effectively convert essentially all of the triacylglycerides into fatty acid alkyl esters, e.g., where no more than about 0.5 wt. % glycerol fatty acid esters (mono-, di- and/or tri-fatty acid esters of glycerol) remain in the reaction product.

After being allowed to react to a significant degree, e.g., at least about 70% conversion of the triglycerides to fatty acid alkyl esters, the reactant stream is commonly separated into a glycerol-enriched stream and a fatty acid alkyl ester-enriched stream. It may be desirable to allow the high shear mixed stream to react for a further period of time, e.g., for a sufficient time such that at least about 90 wt. % of the triglycerides and, more desirably, 95 wt. % or higher has been converted into fatty acid alkyl esters, before separation. The fatty acid alkyl ester-enriched stream may then be further reacted to increase the conversion of triglycerides to fatty acid alkyl esters (FAAE), e.g., by adding additional alkanol and basic transesterification catalyst and subjecting the resulting mixture of FAAE, glycerol esters, alkanol, and catalyst to high shear mixing conditions.

In one embodiment, a reactant stream, which includes triacylglycerides, alkanol, glycerol and a basic transesterification catalyst is formed. The basic transesterification catalyst is typically an alkali metal alkoxide. The alkali metal alkoxide may suitably contain an alkoxide group, which is the counterpart of the alkanol employed in the reaction stream (e.g., a combination of methanol and an alkali metal methoxide such as sodium methoxide and/or potassium methoxide). The reactant stream is mixed under high shear mixing conditions to provide a mixed stream which includes fatty acid alkyl ester and a larger amount of glycerol than was present in the reaction mixture. The mixed stream may suitably be allowed further time to react, e.g., by passing the high shear mixed stream through a suitably sized vessel under low shear mixing conditions. The additional reaction time may be varied as a function of the size of the vessel in relation to the flow rate of the mixed stream through the high shear mixing device, e.g., if the flow rate of the mixed stream is 6 kg/min and the volume of the vessel is sufficient to hold up to about 400 kg of the mixed stream, passage through the vessel can increase the reaction time by up to about one hour. The reactant stream may be formed by combining triacylglycerides and alkanol with a glycerol-containing stream, which includes basic transesterification catalyst.

Where the transesterification process is conducted as a multi-stage operation, the conversion of triacylglycerides to fatty acid alkyl esters in the first stage may be quite high, e.g., resulting in conversion of at least about 70 wt. % of the triglycerides, often at least about 90 wt. % and desirably, 95 wt. % or higher of the triglycerides into fatty acid alkyl esters. In particular where conversion of 90 wt. % of the triglycerides into fatty acid alkyl esters has occurred in an earlier reaction stage(s), the amount of glycerol produced by conversion of the remaining triglycerides may be quite small. Under such conditions, it may be more difficult to achieve efficient separation of the glycerol reaction product from the desired fatty acid alkyl esters. It has been found that more efficient separation may be achieved by adding a small amount of additional glycerol to the transesterification reaction product produced in the final reaction stage. It is believed that this may facilitate phase separation between the fatty acid alkyl esters (e.g., fatty acid methyl esters—“FAME”) and glycerol present in the reaction product mixture. Residual alkanol and alkoxide salt may tend to partition into the glycerol phase, thereby lowering the concentrations of these materials in the separated fatty acid alkyl ester stream and facilitating the removal of such impurities from the desired alkyl ester product. Concentration of the residual alkanol and alkoxide salt in the separated glycerol phase may have an added benefit, since it may be possible to recycle such a glycerol stream back into the reaction mixture of an earlier stage of the transesterification process, thereby providing a source of basic transesterification catalyst, such as alkoxide salt. In some instances, this may obviate the need to introduce fresh transesterification catalyst into the reaction mixture for the earlier stage, lowering the total catalyst requirement for the overall process and enhancing the process economics. Such an approach may have the added benefit of decreasing the total amount of transesterification catalyst present in any waste streams generated by the process, lowering environmental costs of the process.

Another embodiment provides a method of producing fatty acid alkyl esters. The method includes subjecting a mixture of glycerol ester(s), alkanol, and a basic transesterification catalyst, e.g., a catalyst such as an alkali metal alkoxide, to high shear mixing conditions. The reaction mixture may also include a substantial amount of fatty acid alkyl esters, e.g., where the transesterification process is a multi-stage process and the step referred to above is a final stage of the process. To facilitate removal of alkanol, glycerol and/or basic transesterification catalyst (e.g., alkali metal alkoxide) from the product stream, additional glycerol may be added to the product stream to produce an extraction mixture. The addition of the additional glycerol may facilitate separation of the extraction mixture into a glycerol-enriched phase and a FAAE-enriched phase. As discussed elsewhere herein, the source of the additional glycerol may include one or more glycerol-enriched streams recovered from separating the product streams of other reaction stages of a multi-stage process. In some embodiments, the reaction mixture is allowed to react for a sufficient time, e.g., via passage through a stirred vessel, to provide a second product stream having a weight ratio of FAAE to glycerol fatty acid esters of 99.5:1 or higher.

### BRIEF DESCRIPTION OF THE DRAWINGS

FIG. 1 is a schematic drawing of one embodiment of a system for a continuous high shear transesterification process which includes a tank for separating a glycerol phase (“glycerol-enriched stream”) from fatty acid ester phase and allows for the glycerol-enriched stream to be recycled back into the first reactant stream.

FIG. 2 is a schematic drawing of another embodiment of a system for a continuous high shear transesterification process which includes two reaction tanks, two tanks for separating a glycerol phase from a fatty acid ester phase and various options for directing the glycerol-enriched streams from the two separators.

FIG. 3 is a schematic drawing of another embodiment of a system for a continuous high shear transesterification process.

FIG. 4 is a schematic drawing of another embodiment of a system for a continuous high shear transesterification process.

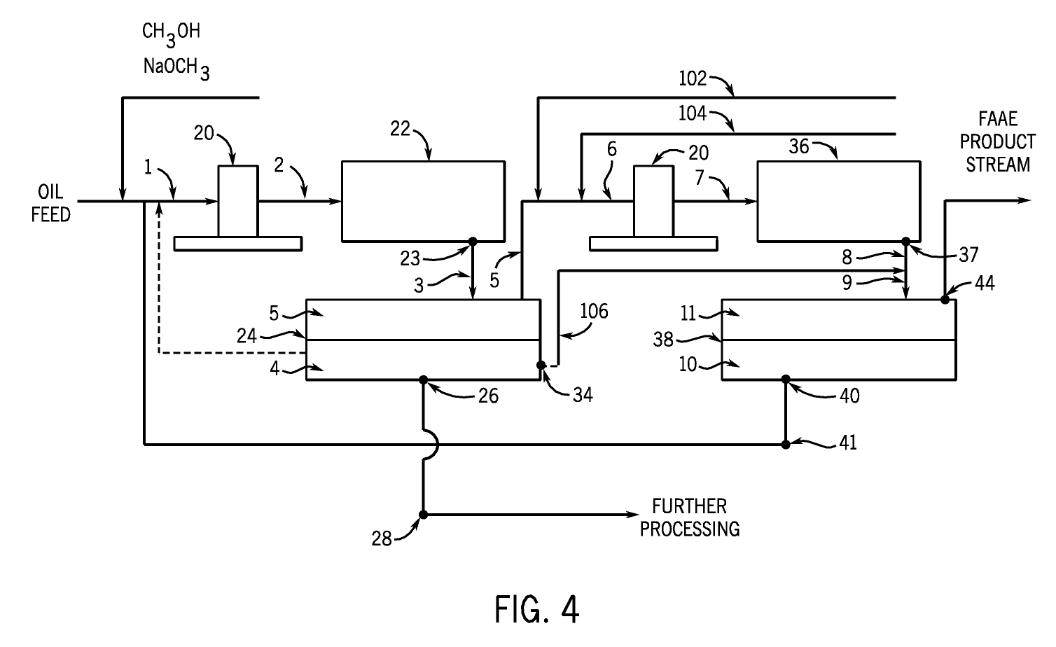

### DETAILED DESCRIPTION

The Figures illustrate various embodiments of the present process for producing fatty acid alkyl esters (“FAAE”) through transesterification of triacylglyceride (“TAG”) oils, such as plant derived oils. Suitable TAG oils which may be transesterified using the methods disclosed herein include plant-based oils and/or animal fats, such as vegetable oils (e.g., soybean oils), soybean oils which have been subjected to prior refining and/or fractionating operations, and/or similar oils derived from other plant sources, such as canola oil, corn oil, sunflower seed oil, cottonseed oil, rapeseed oil, safflower oil, sesame seed oil, peanut oil, palm oil, palm kernel oil, coconut oil, rice bran oil, mustard seed oil, and/or castor oil. One particularly suitable oil is an RBD soybean oil that has been deacidified and degummed (or other comparably processed vegetable oil).

The methods described herein typically involve forming a reactant stream, which includes TAG (e.g., at least about 75 wt. %), alkanol (e.g., about 5 to 20 wt. %), a basic transesterification catalyst (e.g., about 0.05 to 1 wt. %), and optionally, glycerol (typically up to about 10 wt. %). Suitable alkanols may include C1-C6 alkanols and commonly may include methanol, ethanol, or mixtures thereof. Suitable basic transesterification catalysts may include alkali metal alkoxides having from 1 to 6 carbon atoms and commonly may include alkali metal methoxide, such as sodium methoxide and/or potassium methoxide. The basic catalyst is desirably selected such that the alkali metal alkoxide may suitably contain an alkoxide group which is the counterpart of the alkanol employed in the reaction stream (e.g., a combination of methanol and an alkali metal methoxide such as sodium methoxide and/or potassium methoxide). The reactant stream may suitably include about 0.05 to 0.3 wt. % sodium methoxide, at least about 75 wt. % triacylglyceride, about 1 to 7 wt. % glycerol, and at least about 10 wt. % methanol. In some embodiments, the reactant stream may desirably include about 0.05 to 0.25 wt. % sodium methoxide, at least about 75 wt. % triacylglyceride, about 2 to 5 wt. % glycerol, and about 10 to 15 wt. % methanol.

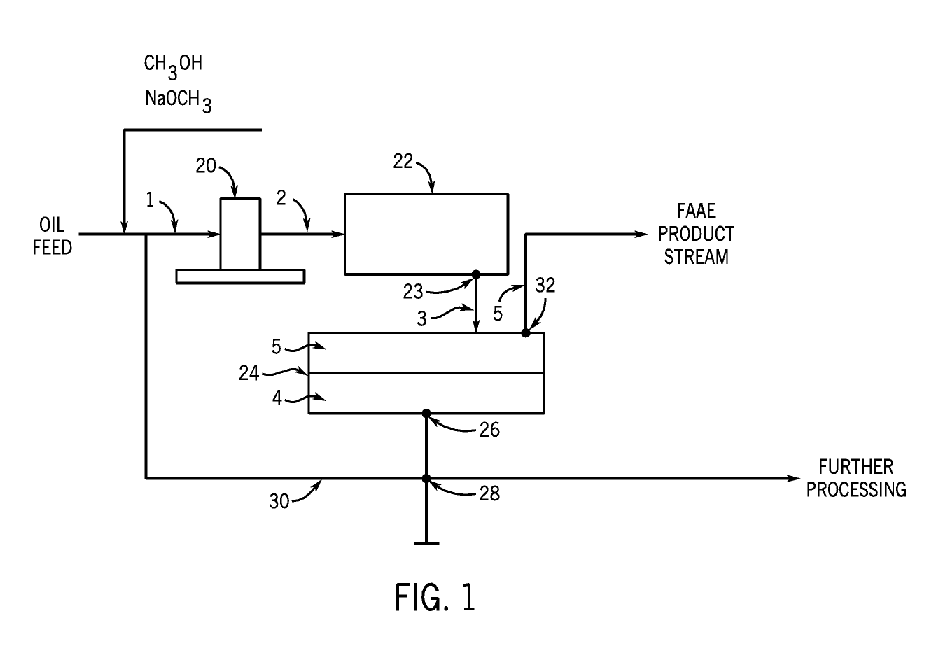

Referring to FIG. 1, the reactant stream 1 is mixed in a high shear mixer 20 to provide a mixed stream 2, which includes TAG and other glycerol fatty acid esters, alkanol, basic transesterification catalyst, glycerol, and FAAE. One suitable shear mixer is a rotor-stator type mixer. Inline high shear mixers, such as inline rotor-stator type high shear mixers, are particularly suitable for use in the present method. Other types of high shear mixers, such as multiple blade tank shear mixers, are available and may be employed in the present transesterification method.

One example of a suitable mixer is the DISPAX REACTOR, an in-line high shear micro-mixer available from IKA Works Inc., employing a rotor-stator design. The capacity of commercially available inline high shear mixers, such as the DISPAX reactor, typically ranges from about 5 to 1,750 kg/min. The performance characteristics of an IKA DISPAX high shear mixer with a rotor-stator generator is compared in Table 1 to the performance parameters for a conventional multiple blade shear mixer (such as one available from ALFA LAVAL) and a stirred tank mixing device.

TABLE 1
Comparison of Performance Characteristics
of Commercial Mixers

| | | | Tank Mixer |
|---|---|---|---|
| | IKA Mixer | Alfa Laval Mixer | Relatively Low |
| | High Shear | High Shear | Shear |
| Type | Inline rotor-stator | Multiple blade | Tank mixer |
| | shear mixer | tank shear mixer | |
| Flow rate | Not limited | Limited | Not limited |
| Power | 60 HP/100 gpm | 30 HP/100 gpm | 1-3 HP/100 gpm |
| Shear | Near 100% | Some loss | Nearly all loss |
| efficiency | | through | through |
| | | circulation | circulation |
| Residence time | 0.1-0.3 sec. | 5-30 sec. | 30-60 min |
| Micro-mixing | Nearly 100% | <100% | ~0% |
| efficiency | | | |
| Shear rate | ≧1,000 | ≧1,000 | 15 |
| (sec⁻¹) | | | |
| Shear freq. | ≧1,000 | circa 900 | 60 |
| (sec⁻¹) | | | |
| Shear number | ≧1,000,000 | circa 1,000,000 | 900 |
| (sec⁻²) | | | |
| Droplet size | ≦5 μm | 1-5 μm | ~20 μm |

For the rotor-stator type mixer (“IKA mixer”), the shear rate is the tip velocity of the rotor divided by the distance between the rotor and stator. The shear frequency is the product of the number of teeth in the rotor, the number of teeth in the stator, and the rotational speed of the rotor (measured in revolutions per second). The shear number is the product of the shear rate and the shear frequency.

In some embodiments, the mixing operation may comprise subjecting the feed stream to high shear conditions having a shear frequency of at least about 500 sec⁻¹. In some embodiments, the shear frequency may be at least about 900 sec⁻¹ and, more suitably about 1,000 to 10,000 sec⁻¹. In some embodiments, the mixing operation may comprise subjecting the feed stream to high shear conditions having a shear rate of at least about 500 sec⁻¹. In some of these embodiments, the shear rate may be at least about 1,000 sec⁻¹ and, often may be about 2,000 sec⁻¹ or higher. The high shear mixing operation may also be characterized in terms of a shear number. The mixing operation may comprise subjecting the feed stream to high shear conditions having a shear number of at least about 100,000 sec⁻² (105 sec⁻²). The high shear mixing conditions may have a shear number of at least about 10⁶ sec⁻², and shear numbers of about 10⁷ sec⁻² or higher may be employed. In many embodiments, e.g., where the high shear mixer is an in-line device, the feed stream has a residence time in the high shear mixer for no more than about 1.0 second and residence times of about 0.05 to 0.5 second, often about 0.1 to 0.3 second, are quite common. The feed stream is typically maintained at a temperature of about 40° C. to 90° C. and, more desirably, about 50° C. to 70° C. during the high shear mixing operation. In many embodiments, particularly where methanol is employed as the alkanol, the transesterification operation may be carried out with the mixed stream at a temperature of about 60° C.

When an inline mixing device of this type is employed, the feed stream enters the rotor-stator type inline high shear mixer through an inlet. The high shear inline micro-mixer may be equipped with more than one rotor-stator generator, each with a choice of ultrafine, fine, medium and/or coarse grade teeth. The high shear inline micro-mixer may be a multi-stage high shear mixer employing progressively finer rotor and stator teeth. The mixed feed stream flows out of an outlet of the high shear inline micro-mixer, which is commonly in downstream fluid connection with a retention tank (which may be a low shear stirred tank).

The mixed stream is typically fed from the high shear mixer to a downstream retention tank where micron size aqueous droplets may begin to agglomerate. The contents of the retention tank may be slowly agitated (under relatively low shear conditions) to allow further reaction and to promote agglomeration while avoiding undesired breakup of agglomerated droplets into smaller droplets. Some retention tanks may include compartment dividers between mixing blades that can aid in the prevention of vertical mixing of the contents within the tank. In some embodiments, the mixed stream is suitably fed to the retention tank through an inlet near the top of the tank, and the mixed stream is drawn from an outlet near the bottom of the tank. Alternatively, other inlet/outlet configurations may be used.

After the high shear mixing operation, the mixed stream 2 may enter a suitably-sized vessel 22 where it is mixed under low shear mixing conditions, e.g. under conditions having a shear number of no more than about 1,000 sec⁻² and, more commonly under conditions having a shear number of no more than about 500 sec⁻², to form a product stream 3 that flows from an outlet 23 of the vessel 22 to a product stream separator 24. Prior to the separation operation, the mixed stream typically resides in the vessel 22 for a time sufficient for at least 70 wt. % of the TAG to be converted into FAAE. In many instances, it may be desirable to allow the high shear mixed stream 2 to react for a further period of time, e.g., for a sufficient time such that at least about 90 wt. % of the triglycerides and, more desirably, 95 wt. % or higher has been converted into fatty acid alkyl esters, before separation. The mixed stream 2 may suitably be allowed further time to react, e.g., by passing the high shear mixed stream 2 through a suitably sized vessel 22 under low shear mixing conditions. The additional reaction time may be varied as a function of the size of the vessel 22 in relation to the flow rate of the mixed stream 2 through the high shear mixing device 20, e.g., if the flow rate of the mixed stream 2 is 6 kg/min and the volume of the vessel 22 is sufficient to hold up to about 400 kg of the mixed stream 2, passage through the vessel 22 can increase the reaction time by up to about one hour. Although the process of producing the fatty acid alkyl esters may be conducted in a variety of modes, including as a batch operation, it is often desirable to conduct the process as a continuous operation.

In the product stream separator 24, the product stream is separated into a glycerol-enriched stream 4 and a FAAE-enriched stream 5. The glycerol-enriched stream 4 generally includes at least a portion of the basic transesterification catalyst. A portion of the glycerol-enriched stream 4 may be allowed to flow from an outlet 26 in the product stream separator 24 and pass through a valve 28 adjusted to a position that allows the glycerol-enriched stream 4 to cycle in a loop 30 to enter the reactant stream 1.

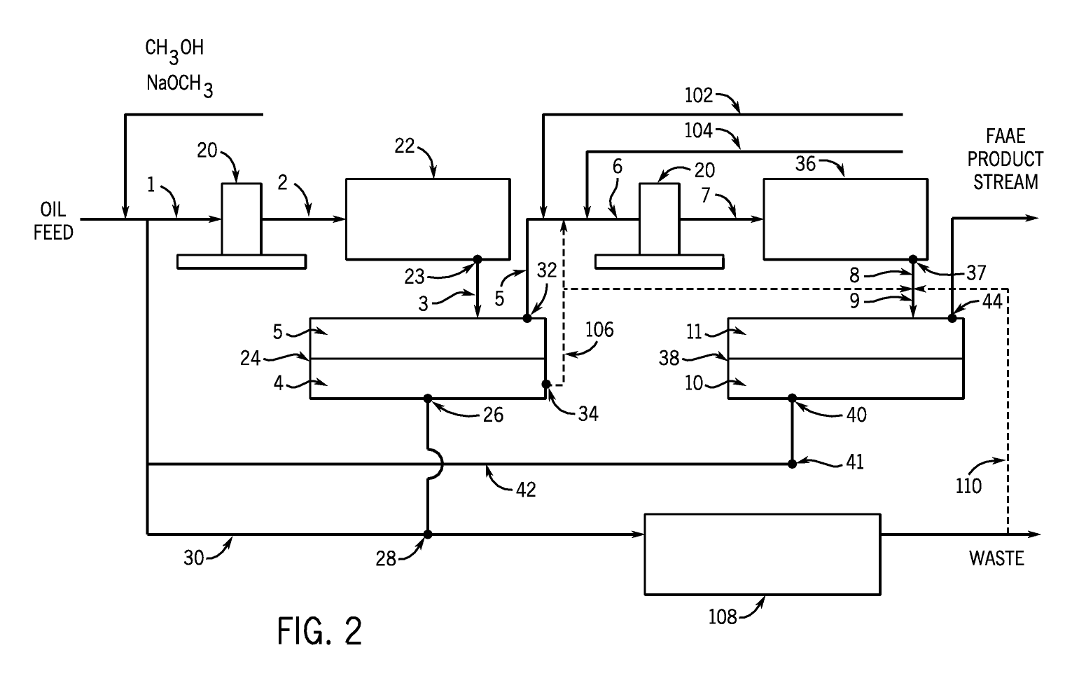

The transesterification process may often be conducted as a multi-stage operation where substantial conversion of triacylglycerides into fatty acid alkyl esters is achieved in a first reaction stage and one or more subsequent stages is employed to effectively convert all of the triacylglycerides into fatty acid alkyl esters, e.g., where no more than about 0.5 wt. % glycerol fatty acid esters (mono-, di- and/or tri-fatty acid esters of glycerol) remain in the reaction product. Referring to FIG. 2, the first stage of the system is substantially the same as the system shown in FIG. 1. The FAAE-enriched stream 5 may be allowed to flow from an outlet 32 in the product stream separator 24 and combine with alkanol 102 and basic transesterification catalyst 104 to form a reactant stream 6. In one embodiment, a portion of the glycerol-enriched stream 4 may flow from an outlet 34 in the separator 24 to combine with the reactant stream 6. In another embodiment, the reactant stream 6 may include at least about 0.1 wt. % transesterification catalyst, about 2 to 5 wt. % alkanol, and have a weight ratio of fatty acid alkyl esters to glyceride fatty acid esters of at least about 10:1. In some embodiments, the reactant stream 6 may commonly include at least about 0.1 wt. % sodium methoxide, about 2 to 5 wt. % methanol, and have a weight ratio of fatty acid alkyl esters to glyceride fatty acid esters of at least about 10:1. The reactant stream 6 may be mixed with a high shear mixer 32 to provide a mixed stream 7 which includes glycerol fatty acid esters, alkanol, basic transesterification catalyst, glycerol, and FAAE. After the high shear mixing operation, the mixed stream 7 may enter a suitably-sized vessel 36 where it commonly is mixed under low shear mixing conditions, to form a product stream 8 that flows from an outlet 37 of the vessel 36 to a product stream separator 38. Prior to the separation operation, the mixed stream 7 desirably resides in the vessel 36 for a sufficient time to form a product stream 8 which includes no more than about 0.5 wt. % glycerol fatty acid ester(s).

In the product stream separator 38, the product stream 8 is separated into a glycerol-enriched stream 10 and a FAAE-enriched stream 11. The glycerol-enriched stream 10 commonly includes at least a portion of the residual basic transesterification catalyst. If desired, a portion of the glycerol-enriched stream 10 may then be allowed to flow from an outlet 40 in the product stream separator 38 and pass through a valve 41 adjusted to a position that allows the glycerol-enriched stream 10 to cycle in a loop 42 to enter the reactant stream 1. In some embodiments, at least a portion of the first glycerol-enriched stream 4 may be combined with TAG and alkanol to produce the first reactant stream 1. In other embodiments, at least a portion of the second glycerol-enriched stream 10 may be combined with TAG and alkanol to produce the first reactant stream 1. In other embodiments, at least a portion of the first glycerol-enriched stream 4 and the second glycerol-enriched stream 10 may be combined with TAG and alkanol to produce the first reactant stream 1. Optionally, a portion of the glycerol-enriched stream 4 may be allowed to flow from an outlet 26 in the product stream separator 24 and pass through a valve 28 adjusted to a position that allows the glycerol-enriched stream 4 to pass to a waste recovery operation, which may include passage through a vacuum stripper 108.

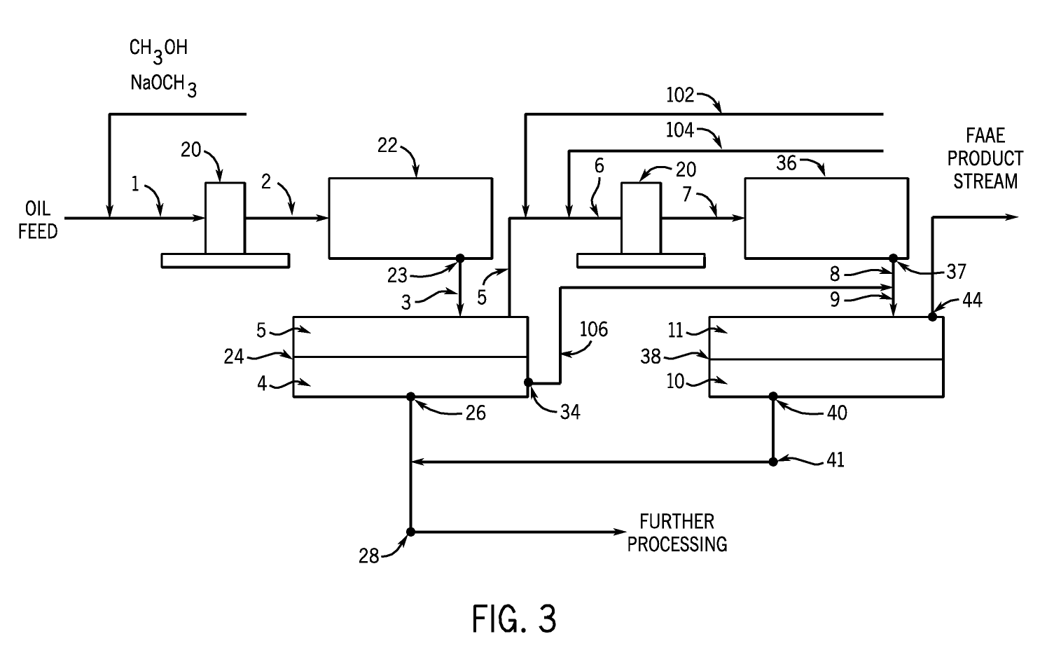

Referring to FIG. 3, the first and second stages of the system are substantially similar to the system shown in FIG. 2. The second mixed stream 7 may be allowed to react for a sufficient time, e.g., via passage through vessel 36, to provide a second product stream 8, suitably having a weight ratio of fatty acid alkyl esters to glycerol fatty acid esters of 99.5:1 or higher. Where conversion of 90 wt. % of the triglycerides into fatty acid alkyl esters has occurred in earlier reaction stage(s), the amount of glycerol produced by conversion of the remaining glyceride esters in the final reaction stage may be quite small. Under such conditions, it may be more difficult to achieve efficient separation of the glycerol reaction product from the desired fatty acid alkyl esters. It has been found that in some instances more efficient separation may be achieved by adding a small amount of additional glycerol to the transesterification reaction product 8 produced in the final reaction stage. It is believed that this may facilitate phase separation between the fatty acid alkyl esters (e.g., fatty acid methyl esters—“FAME”) and glycerol present in the reaction product mixture. In some embodiments, glycerol may be added to the product stream 8 to produce an extraction mixture 9. The source of the glycerol may optionally include at least a portion of the first glycerol-enriched stream 4 that may flow from an outlet 34 in the separator 24 through a connection 106 that adds the glycerol-enriched stream 4 to the product stream 8 to produce the extraction mixture 9. As illustrated in FIG. 2, in some embodiments, the glycerol added to product stream 8 to may optionally include at least a portion of the first glycerol-enriched stream 4 that has been treated to remove alkanol (e.g., methanol) from the glycerol-enriched stream, e.g. by allowing some or all of stream 4 to flow from an outlet 26 in the separator 24 and be directed through a valve 28 to a vacuum stripper 108 to produce a stripped glycerol stream 110. At least a portion of stripped glycerol stream 110 may be added to product stream 8 as a source of glycerol. In another embodiment, the glycerol may optionally include at least a portion of the second glycerol-enriched stream 10 that flows from an outlet 40 in the separator 38 and is directed through a valve 28 to a vacuum stripper 108 that removes methanol from the glycerol-enriched stream to produce a stripped glycerol stream 110. The extraction mixture 9 may flow into the separator 38, where the extraction mixture 9 may be separated into a glycerol-enriched stream 10 and a FAAE-enriched product stream 11, where the glycerol-enriched stream 10 includes at least a portion of the basic transesterification catalyst. In some embodiments, the product stream 8 has a fatty acid ester component which includes at least about 99.5 wt. % fatty acid alkyl esters. In some embodiments, the alkanol is methanol; and the product stream 8 has a fatty acid ester component which includes at least about 99.5 wt. % fatty acid methyl esters (FAME).

### EXAMPLES

The following examples are presented to illustrate the present invention and to assist one of ordinary skill in making and using the same. The examples are not intended in any way to otherwise limit the scope of the invention.

### Example 1

Table 2 provides data for an illustrative high shear transesterification process in which a mixed stream of triacylglyceride (“TAG”) derived from thermally deacidified, high shear degummed soybean oil, methanol, and sodium methoxide was subjected to continuous high shear mixing according to the process depicted in FIG. 1. Methanol (875 g/min) and sodium methoxide (10 g/min) were added to a feed stream of TAG (5,000 g/min) to provide a reactant stream 1. The reactant stream 1 was passed through an high shear mixing device 20 at a flow rate of about 6 kg/min to provide a mixed stream 2. The high shear mixing device was a DISPAX REACTOR, an in-line high shear micro-mixer available from IKA Works Inc., employing a rotor-stator design. The capacity of commercially available inline high shear mixers such as the DISPAX REACTOR typically ranges from about 5 to 1,750 kg/min. The mixed stream 2 was passed to a stirred tank 22 and then to a product separator 24. A valve 28 was adjusted to a position that allowed the product stream 3 to cycle back 30 through the high shear mixer 20, stirred tank 22, and product separator 24. The entire process was operated at about 60° C. with a flow rate of about 6 kg/min. Samples of the product stream 3 were collected and analyzed at various times before and during the high shear mixing process. Referring to Table 2, Sample 1 shows the amounts of various glyceride fatty acid esters—TAG, diacylglycerides (“DAG”), and monoacylglycerides (“MAG”)—as well as fatty acid methyl ester (“FAME”) product, free fatty acids (“FFA”), sterols, and tocopherols present in the reactant stream (1) before it was subjected to high shear mixing. The values in the “FAME” column of Table 1 were calculated as follows:

$$F A M E wt . \% = \frac{F A M E wt .}{F A M E wt . + [ T A G wt . + D A G wt . + M A G wt . ]} \times 100$$

Sample 2 represents the composition of the mixed stream 2 after high shear mixing was initiated. Data for Samples 3 to 7 show the composition of the reactant stream 3 at various times during the high shear mixing process. The results in Table 2 demonstrate that greater than 97% of TAG was converted to FAME after 30 minutes of reacting under high shear mixing conditions, and that greater than 99% of TAG was converted to FAME after 60 minutes of high shear mixing.

TABLE 2

| | | Lipid Composition (% w/w) | | | | | |
|---|---|---|---|---|---|---|---|
| | | | | | | | Sterols |
| | | | | | | | and |
| | Time | | | | | | Tocoph- |
| Sample | (Minutes) | TAG | DAG | MAG | FAME | FFA | erols |
| 1 | 0 | 89.303 | 5.706 | 0.520 | 4.547 | 0.126 | 0.365 |
| 2 | 0 | 76.342 | 9.105 | 1.184 | 11.536 | 0.136 | 0.352 |
| 3 | 5 | 74.303 | 9.604 | 1.300 | 11.295 | 0.108 | 0.372 |
| 4 | 10 | 5.481 | 2.911 | 1.750 | 86.286 | 0.156 | 0.361 |
| 5 | 15 | 1.350 | 1.311 | 1.431 | 93.615 | 0.154 | 0.358 |
| 6 | 30 | ND | 0.125 | 0.911 | 97.824 | 0.145 | 0.354 |
| 7 | 60 | ND | ND | 0.850 | 99.017 | 0.170 | 0.327 |

### Example 2

Table 3 provides data for an illustrative high shear transesterification process in which a mixed stream of triacylglyceride (“TAG”), methanol, and sodium methoxide was subjected to high shear mixing according to the process depicted in FIG. 1. Sodium methoxide (10 g/min), was introduced together with a methanol stream (875 g/min) into a stream of triacylglyceride stock including thermally deacidified, high shear degummed soybean oil (5,000 g/min) to provide a reactant stream 1. The reactant stream 1 was passed through an high shear mixing device 20 at a flow rate of about 6 kg/min to provide a mixed stream 2. The high shear mixing device 20 was a DISPAX REACTOR, as described in Example 1. The mixed stream 2 was then allowed to flow into a stirred tank 22 where it was maintained at a temperature of about 60 and was mixed under low shear conditions, e.g. under conditions having a shear number of no more than about 1,000 sec⁻² and, more commonly under conditions having a shear number of no more than about 500 sec⁻², thereby allowing a glycerol-enriched phase to begin separating from the bulk fatty acid ester phase in the tank. Referring to Table 3, Sample 1 shows the amounts of various glyceride fatty acid esters—TAG, DAG, and MAG—as well as FAME product, FFA, sterols, and tocopherols present in the reactant stream 1 before it was subjected to high shear mixing. Sample 2 represents the composition of the mixed stream 2 after high shear mixing was initiated and the mixed stream was in the stirred tank 22. Data for Samples 3 to 7 show the composition of the reactant stream 3 at various times after the high shear mixing process. The results in Table 3 demonstrate that greater than 98% of TAG was converted to FAME after 30 minutes of reacting under high shear mixing conditions, and that greater than 99% of TAG was converted to FAME after 60 minutes in the stirred tank 22.

TABLE 3

| | | Lipid Composition (% w/w) | | | | | |
|---|---|---|---|---|---|---|---|
| | | | | | | | Sterols |
| | | | | | | | and |
| | Time | | | | | | Tocoph- |
| Sample | (Minutes) | TAG | DAG | MAG | FAME | FFA | erols |
| 1 | 0 | 80.725 | 7.539 | 0.573 | 7.619 | 0.030 | 0.357 |
| 2 | 0 | 62.071 | 12.027 | 2.455 | 20.881 | 0.203 | 0.380 |
| 3 | 5 | 58.093 | 12.527 | 2.862 | 23.492 | 0.197 | 0.359 |
| 4 | 10 | 2.893 | 1.637 | 1.175 | 91.329 | 0.060 | 0.353 |
| 5 | 15 | ND | 0.196 | 0.944 | 97.239 | 0.168 | 0.387 |
| 6 | 30 | ND | ND | 0.782 | 98.515 | 0.155 | 0.346 |
| 7 | 60 | ND | ND | 0.926 | 99.700 | 0.194 | 0.362 |

### Example 3

In a continuous process to produce fatty acid methyl esters (“FAME”) from a triacylglyceride stock, such as an RBD soybean oil, a basic transesterification catalyst, such as sodium methoxide (@ 10 g/min), may be introduced together with a methanol stream (600 to 875 g/min) into a stream of the triacylglyceride stock (5,000 g/min). The sodium methoxide as a solution in the methanol may be combined via a static mixer with the triacylglyceride stock, heated to about 6° C., and then passed through a high shear mixing device, such as a DISPAX REACTOR as described in Example 1. The resulting mixed stream is then allowed to flow into a stirred tank where it is maintained at a temperature of about 6° C. The volume of the tank is selected relative to the flow rate of the reactant stream so as to achieve a desired residence time, e.g., if a residence time in the stirred tank of about one hour is desired, a tank with a volume sufficient to retain about 350 to 450 kg of the mixed stream is employed for mixed stream flow rates of about 6500 to 7000 g/min. The reacting mixture in the stirred tank is mixed under low shear conditions, e.g. the conditions described in Example 2, thereby allowing a glycerol-enriched phase to begin separating from the bulk fatty acid ester phase in the tank.

The residence time of the mixed stream in the stirred tank is selected so that at least about 70 wt. % and, more desireably, about 90 to 95 wt. % of the triacylglyceride stock is converted into FAME when the mixed stream exits the tank. The mixed stream is then separated into fatty acid alkyl ester-enriched stream and a glycerol-enriched stream, which includes large fraction (and in most instances substantially all) of the residual sodium methoxide transesterification catalyst exiting the stirred tank. The glycerol-enriched stream is largely composed of glycerol and may commonly include about up to about 50% of the methanol exiting the stirred tank. If desired, the methanol may be removed from the glycerol-enriched stream and recovered for recycling into the process, e.g., via vacuum stripping, before the glycerol-enriched stream is recycled into other parts of the process. This first fatty acid alkyl ester-enriched stream is predominately composed of FAME with much smaller amounts of fatty acid mono-, di- and triacylglyceride components. When the conversion to FAME is relatively high, e.g., about 90 to 95 wt. %, the fatty acid alkyl ester-enriched stream may be substantially free of any triacylglyceride components, with mono- and diacylglycerides and impurities (such as free fatty acids, sterols and/or tocopherols) making up the remainder of this process stream.

Additional sodium methoxide catalyst (@ 10 g/min) and methanol (@250 g/min) are then added to the fatty acid alkyl ester-enriched stream together with sufficient glycerol to produce a second mixed stream. The amount of glycerol added is sufficient to generate a separate glycerol phase in the product stream generated after reaction of this second mixed stream is essentially complete, e.g., after the second mixed stream has been reacted to convert 99% or more of the original triacylglyceride stock into FAME. Typically, the resulting product stream contains at least about 1 wt. % glycerol (more generally in the range of about 1 to 3 wt. % glycerol). As with the first mixed stream, the reactants in the second stage of the process may be mixed together using a static mixer, heated to a desired reaction temperature (e.g., about 60 C), passed through a high shear mixing device, and then allowed to pass through a stirred tank under low shear mixing conditions. The residence time in the stirred tank is commonly about 30 to 90 minutes during this second stage of the process. The temperature of the mixture in the second stirred tank may be maintained at about 45 to 60 C. It may be desirable to recycle a sufficient amount of the glycerol-enriched stream from the separation operation of the first process stage (the “first glycerol-enriched stream”) into the reactant stream for the second process stage. This can have an added benefit where, as is often the case, a large amount of the basic transesterification catalyst from the first stage remains dissolved in the recovered first glycerol-enriched stream, thereby increasing the amount of catalyst in the second mixed stream.

The resulting process stream exiting the second stage stirred tank is then separated into a second fatty acid alkyl ester-enriched stream and a second glycerol-enriched stream. The second glycerol-enriched stream includes a large fraction (and in most instances substantially all) of the residual sodium methoxide transesterification catalyst exiting the stirred tank. The second fatty acid alkyl ester-enriched stream typically contains a very high percentage of FAME (e.g., where 99% or more of the glycerol fatty acid esters have been converted into FAME) together with impurities, such as sterols and/or tocopherols, and a relatively minor amount of fatty acid glycerol partial esters. For example, the total amount of the mono-, di- and triacylglycerides in such a product stream may be 0.5 wt. % or less.

If desired, the second fatty acid alkyl ester-enriched stream may be further processed to remove impurities, e.g., this product stream may be water washed to remove residual catalyst and any free fatty acid salts and vacuum stripped to remove residual methanol and any other highly volatile components prior to water washing.

### Example 4

A continuous process to produce fatty acid methyl esters from a triacylglyceride stream, such as a 5000 g/min RBD soybean oil stream, may be conducted substantially as described in Example 3 except that no fresh basic transesterification catalyst (e.g. sodium methoxide) is introduced into first reaction mixture. Instead, since substantially all of the sodium methoxide from the second stage of the process operations is partitioned into the second glycerol-enriched phase as it is separated from the overall product stream. Given its relatively low volume, the entirety of the second glycerol-enriched phase (typically about 100 to 250 g/min for the size process stream described above) may be recycled into the first mixed stream (i.e., serve as a source of basic catalyst for the first stage of the transesterification process). This glycerol phase may be about a 2 to 3% of the total product stream exiting the second stage of the reaction process. Depending on the amount of catalyst desired, it may also be advantageous to recycle a portion of the glycerol-enriched phase separated from the product stream exiting the first stage of the transesterification process (the “first glycerol-enriched phase”) into the first mixed stream as well. Typically, this is done such that no more than about 7 wt. % and, more desirably, about 2 to 6 wt. % of the first mixed stream is glycerol.

Such a transesterification process may be conducted where about 0.2 to 0.25 wt. % sodium methoxide is introduced into the second mixed stream, e.g., as a solution in the methanol stream added to form the second mixed stream. Under such conditions, it is often unnecessary to add any fresh sodium methoxide catalyst into the first mixed stream, since the amount of residual catalyst in the glycerol-enriched phase recycled from the second reaction stage may be sufficient to catalyze the transesterification reaction in the first reaction stage, e.g., sufficient to catalyze up to about 90 to 95% conversion of the triacylglycerides into FAME in the first reaction stage. This may be accomplished by including about a 45 to 60 minute residence time of the process stream in the first stirred tank.

In such a process system, a sufficient amount of the first glycerol-enriched phase may be added into the second reactant stream to provide a glycerol content of about 1 wt. % therein. With the inclusion of 200 to 300 g/min of methanol and about 0.2 to 0.25 wt. % sodium methoxide in the second mixed stream, the process can produce a product stream exiting the second stirred tank which includes no more than about 0.5 wt. % glyceride fatty acid esters and has a glycerol content of about 1.5 to 2 wt. %. The second fatty acid alkyl ester-enriched stream produced by such a process can contain a very high percentage of FAME (e.g., where 99.5 wt. % or more of the glycerol fatty acid esters have been converted into FAME) together with very minor amounts of impurities, such as free fatty acids, sterols and/or tocopherols and unreacted glycerol fatty acid esters.

### Example 5

A continuous process to produce fatty acid methyl esters from a triacylglyceride stream may be conducted similar to that described in Example X2. An RBD soybean oil stream (5,000 g/min) is combined with methanol (600 g/min) and a recovered glycerol stream containing basic transesterification catalyst (e.g. sodium methoxide) and minor amounts of methanol to form the reaction mixture in the first stage of the process. The resulting first reaction mixture may contain about 3 to 5 wt. % glycerol and about 0.1 to 0.2 wt. % sodium methoxide. The components of the reaction stream are combined via a static mixer, heated to about 60 C, and then passed through the high shear mixing device. The resulting mixed stream is then allowed to flow into a stirred tank where it is maintained at a temperature of about 60 C. The volume of the tank is selected relative to the flow rate of the reactant stream so as to achieve a desired residence time, e.g., if a residence time in the stirred tank of about one hour is desired, a tank with a volume sufficient to retain about 350 kg of the mixed stream is employed for mixed stream flow rates of about 6,000 g/min. The reacting mixture in the stirred tank is mixed under low shear conditions, thereby allowing a glycerol-enriched phase to begin separating from the bulk fatty acid ester phase in the tank.

The residence time of the first mixed stream in the stirred tank is selected so that at least about 90 to 95% of the triacylglyceride stock has been converted into FAME when the mixed stream exits the tank. The mixed stream is then separated into a first fatty acid alkyl ester-enriched stream and a first glycerol-enriched stream, which includes large fraction (and in most instances substantially all) of the residual sodium methoxide transesterification catalyst exiting the stirred tank. The glycerol-enriched stream is largely composed of glycerol and may include about up to about 50% of the methanol exiting the stirred tank.

Sodium methoxide catalyst (@ 10 g/min) and additional methanol (@250 g/min) are then added to the first fatty acid alkyl ester-enriched stream to produce a second mixed stream. As with the first mixed stream, the reactants in the second stage of the process may be mixed together using a static mixer, heated to a desired reaction temperature (e.g., about 60° C.), passed through a high shear mixing device, and then allowed to pass through a stirred tank under low shear mixing conditions. The residence time in the stirred tank is commonly about 30 to 90 minutes during this second stage of the process. The temperature of the mixture in the second stirred tank may be maintained at about 45 to 60° C.

The resulting process stream exiting the second stage stirred tank (“product stream”) is then combined with a glycerol stream to form an extraction mixture containing sufficient glycerol to form a separate glycerol-containing phase which includes substantial amounts of any residual sodium methoxide and methanol in the reaction product. The first glycerol-enriched stream may suitably be employed as the glycerol stream used to form an extraction mixture. The amount of glycerol added to the product stream from the second stage is commonly such that the extraction mixture has a glycerol content of no more than about 10 wt. %, suitably no more than about 7 wt. %, more desirably, about 2 to 6 wt. %.

The extraction mixture is then separated to provide a second fatty acid alkyl ester-enriched stream and a second glycerol-enriched stream. The second glycerol-enriched stream includes a large fraction (and in most instances substantially all) of the residual sodium methoxide transesterification catalyst exiting the stirred tank. The second fatty acid alkyl ester-enriched stream typically contains a very high percentage of FAME (e.g., where 99 wt. % or more (preferably more than 99.5 wt. %) of the glycerol fatty acid esters have been converted into FAME) together with minor amounts of impurities, such sterols and/or tocopherols, and a very small amount of residual fatty acid glycerol partial esters. For example, the total amount of the mono-, di- and triacylglycerides in such a product stream may be 0.5 wt. % or less and is often in the range of 0.2 to 03. wt. %.

If desired, this second fatty acid alkyl ester-enriched stream may be further processed to remove impurities, e.g., this product stream may be water washed to remove residual catalyst and any free fatty acid salts and vacuum stripped to remove residual methanol and any other highly volatile components prior to water wash.

It may be desirable to recycle some or all of the glycerol-enriched phase separated from the extraction mixture into the first mixed stream. Typically, this is done such that no more than about 7 wt. % and, more desirably, about 3 to 5 wt. % of the first mixed stream is glycerol. Since this recycled glycerol-enriched phase commonly contains a substantial amount of the sodium methoxide catalyst employed in the second reaction stage, it is often advantageous to recycle as much of this second glycerol-enriched phase into the first mixed stream as possible. Thus, the amount of glycerol (e.g., in the form of the first glycerol-enriched phase) which is added to the product stream to form the extraction mixture is suitably selected to generate a volume of second glycerol-enriched phase, which would allow this entire glycerol/catalyst containing stream to be recycled into the first reaction mixture stream.

### ILLUSTRATIVE EMBODIMENTS

Reference is made in the following to a number of illustrative embodiments of the subject matter described herein. The following embodiments describe illustrative embodiments that may include the various features, characteristics, and advantages of the subject matter as presently described. Accordingly, the following embodiments should not be considered as being comprehensive of all of the possible embodiments.

One embodiment provides a method (A) of producing fatty acid alkyl esters comprising mixing a first reactant stream under high shear conditions to provide a first mixed stream which may include triacylglyceride, C1-C6 alkanol, and a basic transesterification catalyst. In the method of embodiment A, the transesterification catalyst may be a basic catalyst. Optionally, the first reactant stream may include about 0.01 to 1 wt. % of the basic catalyst, and the basic may include an alkali metal alkoxide having from 1 to 6 carbon atoms. In the method of embodiment A, the first reactant stream may include about 5 to 20 wt. % C1-C6 alkanol. In the method of embodiment A, the high shear operation may include subjecting the first reactant stream to high shear conditions having a shear frequency of at least about 100,000 sec⁻¹. In the method of embodiment A, the high shear operation may be carried out with the first reactant stream at about 25 to 100° C. Optionally, the first glycerol-enriched stream may comprise at least a portion of the transesterification catalyst, and the method may further comprise separating the first glycerol-enriched stream to provide a first side product output stream and a first catalyst-enriched stream, and recycling the first catalyst-enriched stream into the component materials to provide the first reactant stream. In the method of embodiment A, at least about 90 wt. % of the C1-C6 alkanol may be methanol, and the transesterification catalyst may include alkali metal methoxide. Optionally, the first reactant stream may include about 8 to 12 wt. % methanol and about 0.1 to 0.5 wt. % sodium methoxide. Optionally, the high shear operation may be carried out with the first reactant stream at about 40 to 75° C.; and the method of embodiment A may further include passing the first mixed stream at about 40 to 75° C. through a vessel such that the first mixed stream may have a residence time in the vessel which may be sufficient for at least 50% of the triacylglyceride to be converted to fatty acid alkyl esters.

Another embodiment provides a method (B) of producing fatty acid alkyl esters comprising mixing component materials to provide a first reactant stream which may include triacylglyceride, C1-C6 alkanol, and a transesterification catalyst, subjecting the first reactant stream to high shear mixing conditions to provide a first mixed stream, and separating the first mixed stream into a first glycerol-enriched stream and a first fatty acid alkyl ester-enriched stream. Optionally, the method of embodiment B may further comprise passing the first mixed stream through a vessel prior to the separation operation. Optionally the vessel may be a holding tank. Optionally the vessel may be a pipe.

Another embodiment provides a method (C) of producing fatty acid alkyl esters comprising mixing a first reactant stream under high shear conditions to provide a first mixed stream that may comprise triacylglyceride, C1-C6 alkanol, and a transesterification catalyst and passing the first mixed stream through a vessel to provide a first product stream such that the first mixed stream may have a residence time in the vessel which may be sufficient for at least 50% of the triacylglyceride to be converted into fatty acid alkyl esters. The method of embodiment C may further comprising separating the first product stream to provide a first glycerol-enriched stream and first fatty acid alkyl ester-enriched stream. The method of embodiment C may further comprise deactivating the transesterification catalyst in the first product stream prior to the separation operation and separating the deactivated first product stream to provide a first glycerol-enriched stream and a first fatty acid monoester-enriched stream. The transesterification catalyst may optionally be a basic catalyst and the deactivating operation may comprise adding sufficient acid to the first product stream to at least completely neutralize the basic catalyst.

Another embodiment provides a method (D) of producing fatty acid alkyl esters comprising mixing a first reactant stream including triacylglyceride, C1-C6 alkanol, and a transesterification catalyst under high shear mixing conditions to provide a first mixed stream, passing the first mixed stream through a vessel to provide a first product stream, such that the first mixed stream may have a residence time in the vessel which may be sufficient for at least 50% of the triacylglyceride to be converted into fatty acid alkyl esters, separating the first product stream into a first glycerol-enriched stream and a first fatty acid alkyl ester-enriched stream, adding additional alkanol and transesterification catalyst to the first fatty acid alkyl ester-enriched stream to provide a second reactant stream; and mixing the second reactant stream under high shear mixing conditions to provide a second mixed stream. Optionally, the method of embodiment D may further comprise separating the first glycerol-enriched stream into a first side product output stream and a first catalyst-enriched stream, and recycling the first catalyst-enriched stream into the first reactant stream. Optionally, the method of embodiment D may further comprise passing the second mixed stream through a vessel to provide a second product stream and separating the second product stream into a second glycerol-enriched stream and a second fatty acid alkyl ester-enriched stream. Optionally, the second fatty acid alkyl ester-enriched stream may be purified to provide a fatty acid alkyl ester product stream, which may include at least about 95 wt. % of one or more fatty acid methyl esters. Optionally, the method of embodiment D may further comprise separating the second glycerol-enriched stream into a second side product output stream and a second catalyst-enriched stream and recycling the second catalyst-enriched stream into the second reactant stream.

Another embodiment provides a method (E) of producing fatty acid alkyl esters comprising mixing a first reactant stream that may comprise triacylglyceride, C1-C6 alkanol, and a transesterification catalyst under high shear mixing conditions to provide a first mixed stream, passing the first mixed stream through a vessel to provide a first product stream, separating the first product stream into a first glycerol-enriched stream and a first fatty acid alkyl ester-enriched stream, adding additional alkanol and transesterification catalyst to the first fatty acid alkyl ester-enriched stream to provide a second reactant stream, mixing the second reactant stream under high shear mixing conditions to provide a second mixed stream, passing the second mixed stream through a vessel to provide a second product stream, separating the second product stream into a second glycerol-enriched stream and a second fatty acid alkyl ester-enriched stream, separating the first glycerol-enriched stream into a first side product output stream and a first catalyst-enriched stream, and recycling the first catalyst-enriched stream into the first reactant stream and/or the second reactant stream. Optionally, the first mixed stream may have a residence time in the vessel which is sufficient for at least 50% of the triacylglyceride to be converted into fatty acid alkyl esters. Optionally, the second mixed stream may have a residence time in the vessel such that at least about 99.5 wt. % of fatty acids in the second product stream are present as fatty acid alkyl esters. Optionally, the method of embodiment E may further comprise separating the second glycerol-enriched stream into a second side product output stream and a second catalyst-enriched stream, and recycling the second catalyst-enriched stream into the first reactant stream and/or the second reactant stream.

The invention has been described with reference to various specific and illustrative embodiments and techniques. However, one skilled in the art will recognize that that many variations and modifications may be made while remaining within the spirit and scope of the invention.

In addition, where features or aspects of the invention are described in terms of Markush groups or other grouping of alternatives, those skilled in the art will recognize that the invention is also thereby described in terms of any individual member or subgroup of members of the Markush group or other group.

Unless indicated to the contrary, where various numerical values are provided for embodiments, additional embodiments are contemplated by taking any two different values as the endpoints of a range. Such ranges are also within the scope of the invention described herein.

What is claimed is:

1. A method of producing fatty acid alkyl esters comprising:
a) forming a first reactant stream, which comprises triacylglycerides, alkanol, glycerol and a basic transesterification catalyst; and
b) mixing the first reactant stream under high shear mixing conditions to provide a first mixed stream; wherein the first mixed stream comprises fatty acid alkyl ester.

2. The method of claim 1, wherein forming the first reactant stream comprises combining the triacylglycerides and alkanol with a glycerol stream which comprises basic transesterification catalyst.

3. The method of claim 2, further comprising:
c) separating the first mixed stream into a first glycerol-enriched stream and a first fatty acid alkyl ester-enriched stream; wherein the first glycerol-enriched stream includes at least a portion of the basic transesterification catalyst;
wherein combining the glycerol stream with the triglycerides and alkanol comprises recycling at least a portion of the first glycerol-enriched stream into the first reactant stream.

4. The method of claim 1, wherein the first reactant stream includes no more than about 10 wt. % glycerol.

5. The method of claim 1, wherein the basic transesterification catalyst comprises alkali metal alkoxide.

6. The method of claim 1, further comprising adding alkanol and basic transesterification catalyst to the first fatty acid alkyl ester-enriched stream to provide a second reactant stream; and
mixing the second reactant stream under high shear mixing conditions to provide a second mixed stream.

7. The method of claim 6, further comprising separating the second mixed stream to provide a second fatty acid alkyl ester-enriched stream and a second glycerol-enriched stream, which comprises basic transesterification catalyst.

8. The method of claim 7, wherein forming the first reactant stream comprises combining the triacylglycerides and alkanol with:
(i) at least a portion of the first glycerol-enriched stream,
(ii) at least a portion of the second glycerol-enriched stream, or
(iii) a combination thereof.

9. The method of claim 7, wherein forming the first reactant stream comprises combining the triacylglyceride and alkanol with the second glycerol-enriched stream.

10. The method of claim 1, wherein the first mixed stream is allowed to react prior to the separation operation for a sufficient time for at least 70 wt. % of the triacylglyceride to be converted into fatty acid alkyl esters.

11. The method of claim 10, wherein allowing the first mixed stream to react comprises passing the first mixed stream through a vessel under low shear conditions.

12. The method of claim 1, wherein the first reactant stream comprises:
about 1 to 5 wt. % glycerol;
about 0.05 to 0.25 wt. % sodium methoxide;
at least about 75 wt. % triacylglyceride; and
at least about 10 wt. % methanol.

13. The method of claim 1, wherein the process of producing the fatty acid alkyl esters is a continuous process.

14. The method of claim 2, further comprising:
c) separating the first mixed stream into a first glycerol-enriched stream and a first fatty acid alkyl ester-enriched stream;
d) adding alkanol and basic transesterification catalyst to the first fatty acid alkyl ester-enriched stream to provide a second reactant stream;
e) mixing the second reactant stream under high shear mixing conditions to provide a second mixed stream;
f) allowing the second mixed stream to react to produce a product stream;
g) adding glycerol to the product stream to produce a extraction mixture; and
h) separating the extraction mixture to provide a second fatty acid alkyl ester-enriched stream and a second glycerol-enriched stream, which comprises basic transesterification catalyst;
wherein forming the first reactant stream comprises combining the triacylglyceride and alkanol with at least a portion of the second glycerol-enriched stream.

15. The method of claim 14, wherein adding glycerol to the product stream comprises adding at least a portion of the first glycerol-enriched stream to the product stream.

16. The method of claim 14, wherein the product stream has a fatty acid ester component which includes at least about 99.5 wt. % fatty acid alkyl esters.

17. The method of claim 14, wherein the alkanol is methanol; and the product stream has a fatty acid ester component which includes at least about 99.5 wt. % fatty acid methyl esters (FAME).

18. The method of claim 14, further comprising removing alkanol via vacuum stripping from the first glycerol-enriched stream to form a stripped glycerol stream;
wherein adding glycerol to the product stream comprises at least a portion of the stripped glycerol stream to the product stream.

19. A method of producing fatty acid alkyl esters comprising:
a) mixing a first reactant stream under high shear conditions to provide a first mixed stream;
wherein the first reactant stream comprises triacylglycerides, alkanol, and a basic transesterification catalyst; and the first mixed stream comprises fatty acid alkyl ester;
b) separating the first mixed stream to provide a first glycerol-enriched stream and a first fatty acid alkyl ester-enriched stream;
c) adding alkanol and basic transesterification catalyst to the first fatty acid alkyl ester-enriched stream to provide a second reactant stream;
d) mixing the second reactant stream under high shear mixing conditions to provide a second mixed stream;
e) adding glycerol to the second mixed stream to provide an extraction mixture; and
f) separating the extraction mixture into a second glycerol-enriched stream and a second fatty acid alkyl ester-enriched stream.

20. The method of claim 19, further comprising forming the first reactant stream by combining the triacylglycerides and alkanol with the second glycerol-enriched stream, which comprises basic transesterification catalyst.

21. The method of claim 19, wherein the first mixed stream is allowed to react prior to the separation operation for a sufficient time for at least about 90% of the triacylglycerides to be converted into fatty acid alkyl esters.

22. The method of claim 21, wherein the second mixed stream is allowed to react for a sufficient time to form a product stream which includes no more than about 0.5 wt. % glycerol fatty acid ester.

23. The method of claim 22, wherein allowing the second mixed stream to react comprises passing the second mixed stream through a vessel under low shear conditions.

24. The method of claim 19, wherein the second reactant stream comprises:
at least about 0.1 wt. % transesterification catalyst; and
about 2 to 5 wt. % alkanol; and
has a weight ratio of fatty acid alkyl esters to glyceride fatty acid esters of at least about 10:1.

25. The method of claim 19, wherein the first reactant stream comprises:
about 2 to 5 wt. % glycerol;
about 0.05 to 0.25 wt. % sodium methoxide;
at least about 75 wt. % triacylglyceride; and
at least about 10 wt. % methanol; and
the second reactant stream comprises:
at least about 0.1 wt. % sodium methoxide;
about 2 to 5 wt. % methanol; and
has a weight ratio of fatty acid alkyl esters to glyceride fatty acid esters of at least about 10:1.

26. The method of claim 19, wherein adding glycerol to the second mixed stream comprises adding at least a portion of the first glycerol-enriched stream to the second mixed stream.

27. The method of claim 19, wherein the second mixed stream is allowed to react for a sufficient time to provide a second product stream having a weight ratio of fatty acid alkyl esters to glycerol fatty acid esters of at least about 99.5:1.

28. The method of claim 1, wherein the first reactant stream comprises:
about 1 to 6 wt. % glycerol;
about 0.05 to 0.3 wt. % sodium methoxide;
at least about 75 wt. % triacylglyceride; and
at least about 10 wt. % methanol.
